(19) United States
(12) Patent Application Publication
(10) Pub. No.: US 2017/0091165 A1
(43) Pub. Date: Mar. 30, 2017

(54) RECORDING MEDIUM, APPLICATION ACTIVATION CONTROL METHOD, AND INFORMATION PROCESSING APPARATUS

(71) Applicant: FUJITSU LIMITED, Kawasaki-shi (JP)

(72) Inventors: Kenichiro Hayashi, Yokohama (JP); Hiroki Tanaka, Nagareyama (JP)

(21) Appl. No.: 15/239,275

(22) Filed: Aug. 17, 2016

(30) Foreign Application Priority Data
Sep. 28, 2015 (JP) 2015-190483

(51) Int. Cl. G06F 17/24; G06F 19/00; G06F 17/27

(52) U.S. Cl. CPC G06F 17/243; G06F 17/271; G06F 17/2755; G06F 17/2785; G06F 19/322; G06F 19/3456

(57) ABSTRACT

A non-transitory, computer-readable recording medium stores therein, an application activation control program causing a computer to execute a process including receiving an input of a text document into an input field; and detecting completion of the input of the text document into the input field and referring to a storage device configured to store therein keywords and identification information of applications in a correlated manner, the computer further activating an application corresponding to the keyword, when a keyword is included in the received text document.

### CROSS REFERENCE TO RELATED APPLICATIONS

This application is based upon and claims the benefit of priority of the prior Japanese Patent Application No. 2015-190483, filed on Sep. 28, 2015, the entire contents of which are incorporated herein by reference.

### FIELD

The embodiments discussed herein are related to a recording medium, an application activation control method, and an information processing apparatus.

### BACKGROUND

A conventional electronic medical chart system electronically records and stores medical charts (clinical charts) recorded by health care professionals such as physicians and nurses. When inputting a medical chart, a physician registers a disease name determined from a patient's chief complaint and objective information or gives instructions for details of a necessary prescription, injection, testing, etc., in some cases. The registration of the disease name and the instructions for details of the prescription, injection, testing, etc., are made by using tools different from a tool for inputting the medical chart.

Related prior art includes, for example, a technique of extracting and displaying a symptom keyword matching a preregistered symptom keyword from input medical findings, and reading from a database and displaying a history of orders issued by a physician in the past for a specified symptom keyword. In another technique, when an activation instruction from a user is received for an input tool supporting input of clinical information to an input region and a predetermined keyword is included in the clinical information already input in the input region, the keyword is transferred to the input tool. For examples, refer to Japanese Laid-Open Patent Publication Nos. 2005-38262 and 2010-286922.

### SUMMARY

According to an aspect of an embodiment, a non-transitory, computer-readable recording medium stores therein, an application activation control program causing a computer to execute a process including receiving an input of a text document into an input field; and detecting completion of the input of the text document into the input field and referring to a storage device configured to store therein keywords and identification information of applications in a correlated manner, the computer further activating an application corresponding to the keyword, when a keyword is included in the received text document.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory view of an example of an application activation control method according to an embodiment;

FIG. 2 is an explanatory diagram of a system configuration example of a medical support system 200;

FIG. 3 is a block diagram of an example of hardware configuration of a server 201;

FIG. 4 is a block diagram of an example of hardware configuration of a client apparatus 202;

FIG. 5 is an explanatory diagram of an example of storage contents of an activation app table 230;

FIG. 6 is an explanatory diagram of an example of storage contents of an input keyword table 240;

FIG. 7 is an explanatory view of an example of a medical chart input screen 700;

FIG. 8 is a block diagram of a functional configuration example of the client apparatus 202;

FIG. 9 is an explanatory view of an example of activation of an app corresponding to a keyword;

FIG. 10 is an explanatory view of an example of a prescription order screen 1000;

FIG. 11 is an explanatory view of an example of an injection order screen 1100;

FIG. 12 is an explanatory view of an example of automatic input into an input item of an app; and

FIG. 13 is a flowchart of an example of an application activation control process procedure of the client apparatus 202.

### DESCRIPTION OF THE INVENTION

Embodiments of an application activation control programs, an application activation control method, and an information processing apparatus will be described in detail with reference to the accompanying drawings.

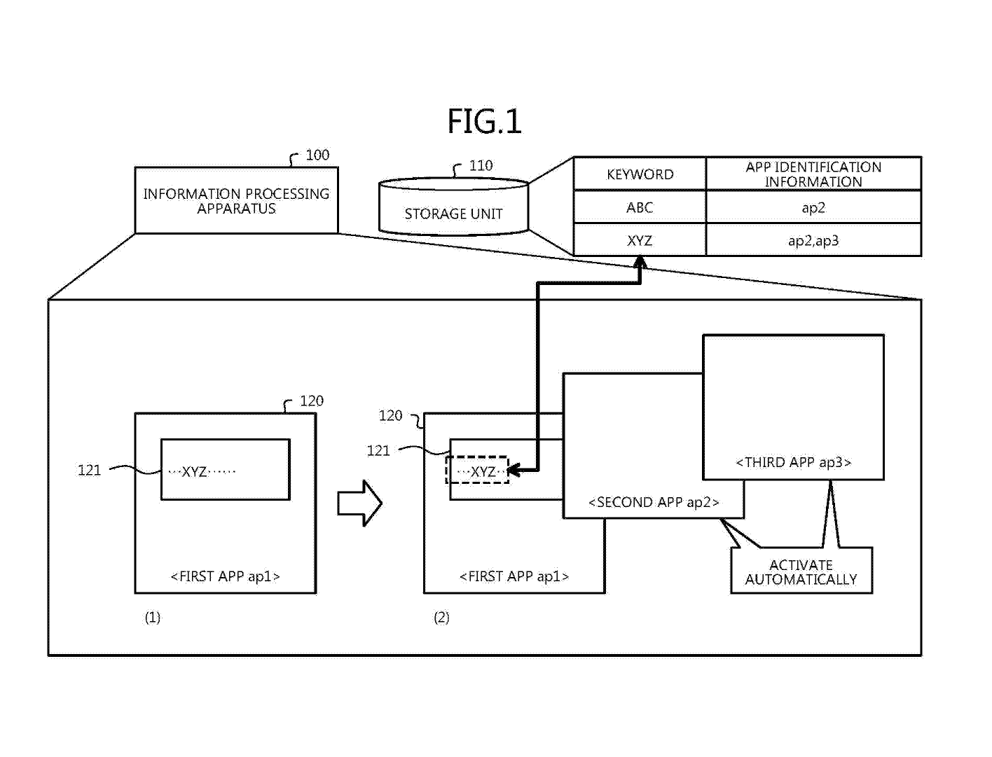

FIG. 1 is an explanatory view of an example of an application activation control method according to an embodiment. In FIG. 1, an information processing apparatus 100 is a computer having a storage unit 110 and controlling activation of applications. The information processing apparatus 100 may be, for example, a personal computer or a tablet terminal or may be a server.

The storage unit 110 is a storage device storing keywords and identification information of applications in a correlated manner. An application is computer software used for specific use and purpose. In the following descriptions, an application may simply be referred to as an “app”.

During work using a certain app, it may be desirable to activate and use another app. For example, when inputting a medical chart at a medical facility such as a hospital or a clinic, a physician registers a disease name determined from a patient's chief complaint and objective information or gives instructions for details of necessary prescription, injection, testing, etc., in some cases. The registration of the disease name and the instructions for details of treatment such as prescription, injection, testing, etc., are made using apps, so-called order tools, different from an app for inputting the medical chart.

In particular, the order tools for registering a disease name and giving instructions for details of a prescription, injection, testing, etc. are functions independent of the app for inputting a medical chart. On the other hand, if a physician must activate the order tools by oneself during or after input of a medical chart, operations to be performed by the physician increase, resulting in disruption of the physician's thought process during medical examination or a reduction in work efficiency.

By registering a set of collectively activated apps (e.g., order tools), the number of user's operations may be reduced. However, the work is required for determining and registering the collectively activated apps as a set in advance, and a user operation is also required for activating the apps registered as the set.

Therefore, in this embodiment, description will be made of an application activation control method of preventing an increase in the number of user operations by automatically activating an app corresponding to an input keyword. A process example of the information processing apparatus 100 will hereinafter be described.

(1) The information processing apparatus 100 receives input of a text document to an input field. The text document in this case is text data of a document including characters or character strings represented by character codes. For example, during execution of a predetermined app, the information processing apparatus 100 receives a text document input to a predetermined input field of the app.

The predetermined app is, for example, an app capable of creating and editing a document, for example. For example, the predetermined app is a medical chart input tool for inputting a medical chart (clinical chart). The predetermined input field may be set arbitrary. For example, assuming that the predetermined app is a “medical chart input tool,” the predetermined input field is an input field for inputting a condition, treatment, course, etc. of a patient's disease.

In the example of FIG. 1, it is assumed that the information processing apparatus 100 receives a text document input to an input field 121 in a screen 120 of a first app ap1 during execution of the first app ap1. A display (not depicted) displaying the screen 120 of the first app ap1 may be included in the information processing apparatus 100 or may be included in another computer.

(2) When detecting the completion of input of the text document to the input field, the information processing apparatus 100 refers to the storage unit 110 and, if a keyword is included in the received text document, activates an app corresponding to the keyword. The storage unit 110 has identification information of apps stored in correlation with keywords. For the keywords, for example, phrases are used from which use of an app corresponding to a keyword may be deduced when the keyword is input.

For example, if a disease name (e.g., a cold or influenza) is input in the input field of the medical chart input tool, it may be deduced that a disease name order tool is used for registering the disease name. The disease name order tool is a tool for registering a disease name. Therefore, the storage unit 110 may have identification information of the disease name order tool stored in correlation with a “disease name.”

If a drug name is input in the input field of the medical chart input tool, it may be deduced that a prescription order tool or an injection order tool is used for giving instructions for details of prescription or injection. The prescription order tool is a tool for giving instructions for details of a prescription. The injection order tool is a tool for giving instructions for details of injection. Therefore, the storage unit 110 may have identification information of the prescription order tool and the injection order tool stored in correlation with a “drug name”.

Prescription, injection, laboratory testing, and surgery (including anesthesia, blood transfusion, etc.) may be required depending on a symptom or a disease name. For example, in the case of influenza, a patient may have a high fever and it may be deduced that a prescription or an injection is applied. In particular, if a certain symptom or disease name is input in the input field of the medical chart input tool, it may be deduced that order tools for prescription, injection, laboratory testing, surgery, etc. are used.

Therefore, the storage unit 110 may have identification information of the order tools for prescription, injection, laboratory testing, surgery, etc. stored in correlation with a “certain symptom” or a “certain disease name.” The laboratory testing order tool is an order tool for giving instructions for details of laboratory testing. The surgery order tool is an order tool for giving instructions for derails of surgery.

A disease name may be predicted from a drug name in some cases. In particular, it may be deduced from some drug names that laboratory testing or surgery is performed. Therefore, the storage unit 110 may have identification information of the order tools for laboratory testing, surgery, etc. stored in correlation with a “certain drug name”.

In the example of FIG. 1, it is assumed that the storage unit 110 has identification information “ap2” of a second app ap2 stored in correction with a keyword “ABC”. It is also assumed that the storage unit 110 has the identification information “ap2” of the second app ap2 and identification information “ap3” of a third app ap3 stored in correction with a keyword “XYZ”.

In this case, for example, when detecting the completion of input of the text document to the input field 121, the information processing apparatus 100 executes natural language processing for the received text document to divide the text document by delimiting each word. The completion of input of the text document to the input field 121 is detected according to execution of an operation of confirming characters or character strings input to the input field 121, for example.

The information processing apparatus 100 compares a divided word with the keywords stored in the storage unit 110 to search for a keyword matching the word. If a keyword is retrieved, the information processing apparatus 100 determines that the keyword is included in the text document. It is assume that the keyword “XYZ” is included in the text document input to the input field 121 in the screen 120 of the first app ap1. In this case, the information processing apparatus 100 refers to the storage unit 110 to activate the second app ap2 and the third app ap3 corresponding to the keyword “XYZ”.

As described above, the information processing apparatus 100 may automatically activate an app corresponding to a keyword included in the text document input to the input field and may prevent an increase in the number of user operations. For example, taking the case of inputting a medical chart (clinical chart) of a patient as an example, order tools corresponding to keywords included in a text document input to the medical chart input tool may be activated automatically. As a result, during input of a medical chart etc., operations to be performed by a physician may be reduced to prevent a reduction in work efficiency.

The case of applying the information processing apparatus 100 depicted in FIG. 1 to a medical support system will be described. The medical support system is a system supporting medical care in a medical facility such as a hospital or clinic.

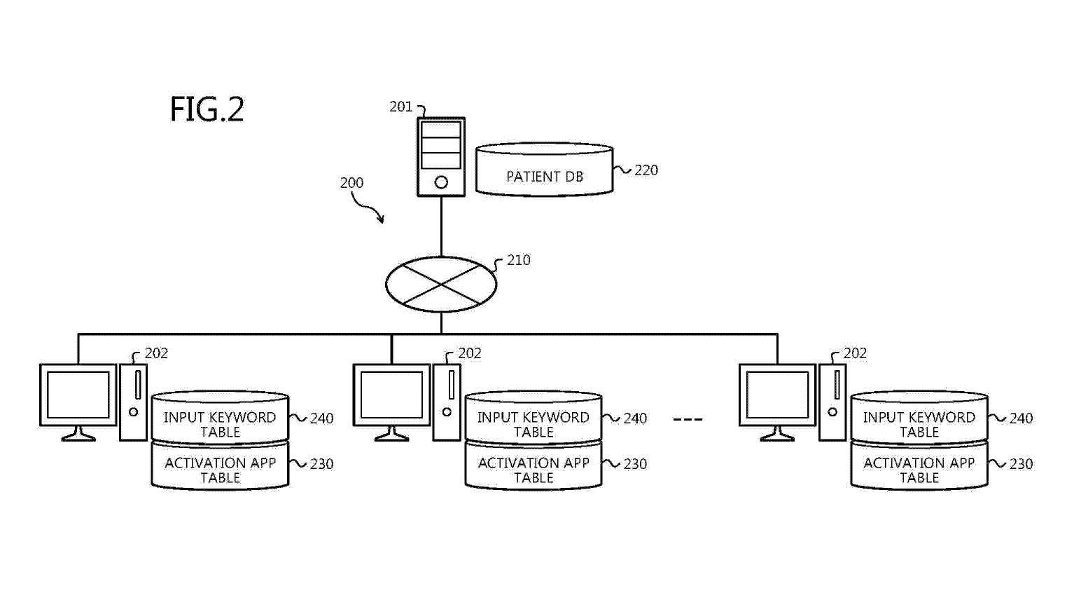

FIG. 2 is an explanatory diagram of a system configuration example of a medical support system 200. In FIG. 2, the medical support system 200 includes a server 201 and multiple client apparatuses 202. In the medical support system 200, the server 201 and the multiple client apparatuses 202 are connected through a wired or wireless network 210. The network 210 is, for example, a local area network (LAN), a wide area network (WAN), or the internet.

The server 201 is a computer having a patient database (DB) 220 and managing clinical information of patients. The clinical information represents clinical records of patients and is stored in the patient DB 220. The clinical information includes information related to patient information (e.g., patient type, name, age, blood type, height, and weight), medical charts (clinical charts), prescriptions, treatment, laboratory testing, and surgery, for example.

The client apparatuses 202 are computers used by health care professionals such as physicians and nurses. The client apparatuses 202 each have an activation app table 230 and an input keyword table 240. For example, the client apparatuses 202 are personal computers, notebook PCs, or tablet terminals, for example.

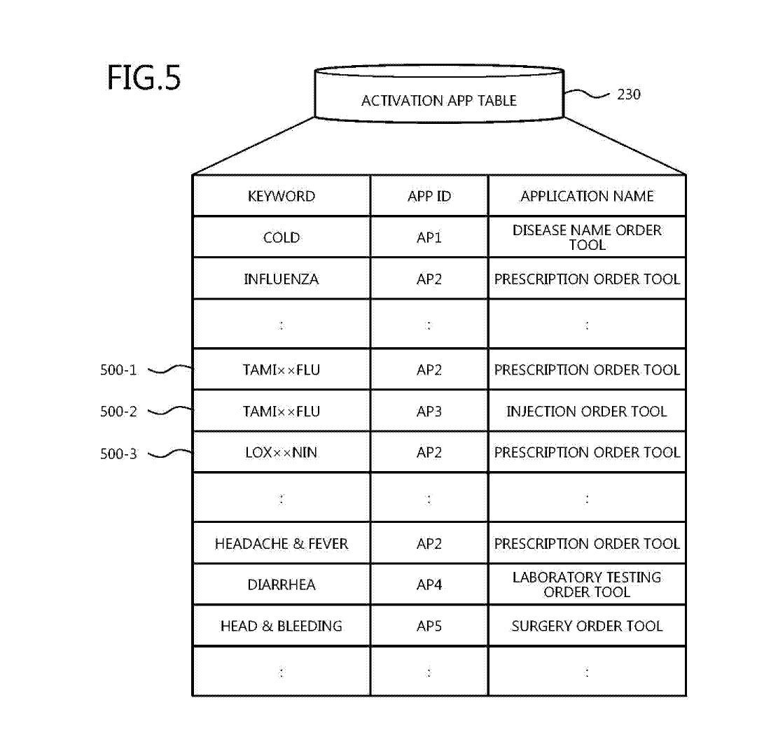

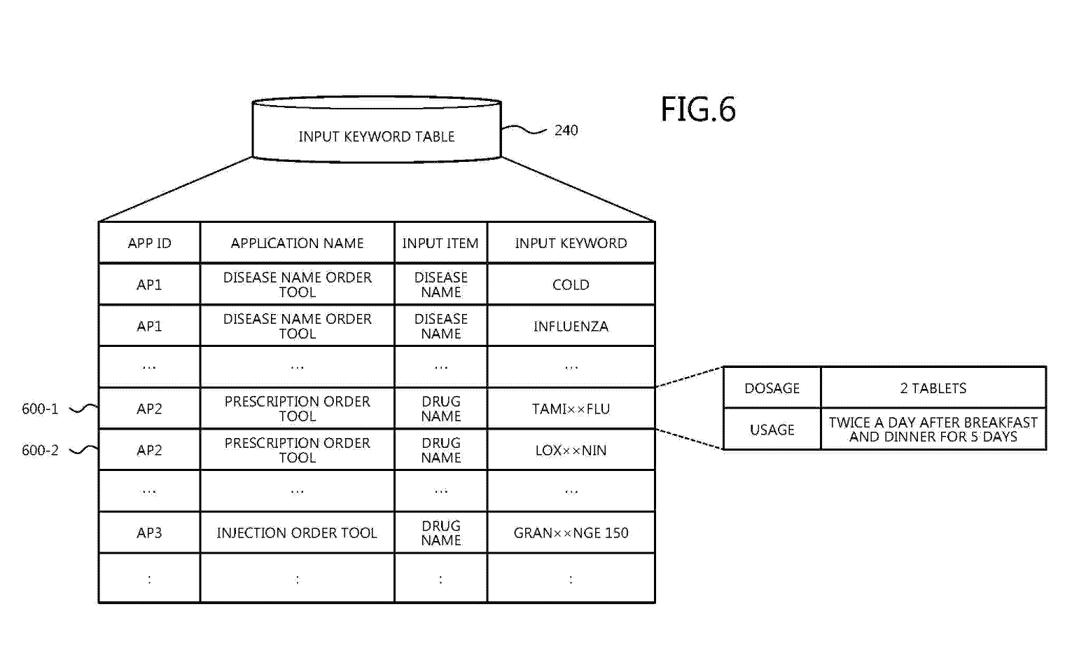

For example, the information processing apparatus 100 depicted in FIG. 1 corresponds to each of the client apparatuses 202. For example, the storage unit 110 depicted in FIG. 1 corresponds to the activation app table 230. Storage contents of the tables 230, 240 will be described later with reference to FIGS. 5 and 6.

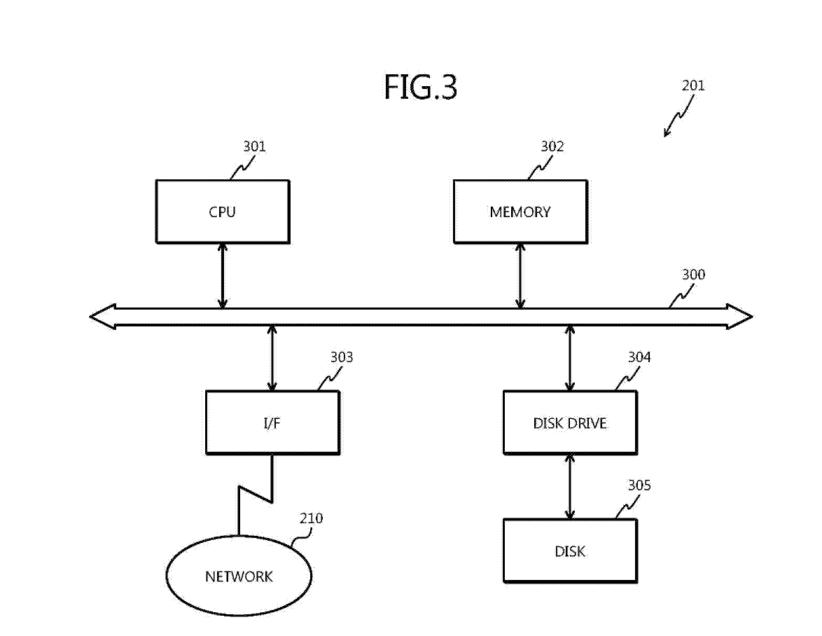

FIG. 3 is a block diagram of an example of hardware configuration of the server 201. In FIG. 3, the server 201 includes a central processing unit (CPU) 301, memory 302, an interface (I/F) 303, a disk drive 304, and a disk 305. The respective components are connected by a bus 300.

Here, the CPU 301 governs overall control of the server 201. The memory 302, for example, includes read-only memory (ROM), random access memory (RAM), and flash ROM. In particular, for example, the flash ROM and the ROM store various types of programs and the RAM is used as a work area of the CPU 301. A program stored in the memory 302 is loaded onto the CPU 301 and an encoded process is executed by the CPU 301.

The I/F 303 is connected to the network 210 through a communications line and is connected an external device (e.g., the client apparatus 210 depicted in FIG. 2) via the network 210. The I/F 303 administers an internal interface with the network 210 and controls the input and output of data from an external device. The I/F 303, for example, may be a model, a LAN adapter, or the like.

The disk drive 304, under the control of the CPU 301, controls the reading and writing of data with respect to the disk 305. The disk 305 stores data written thereto under the control of the disk drive 304. The disk 305 may be, for example, a magnetic disk, an optical disk, or the like.

In addition to the configuration above, the server 201, for example, may include a solid state drive (SSD), a keyboard, a mouse, a display, etc.

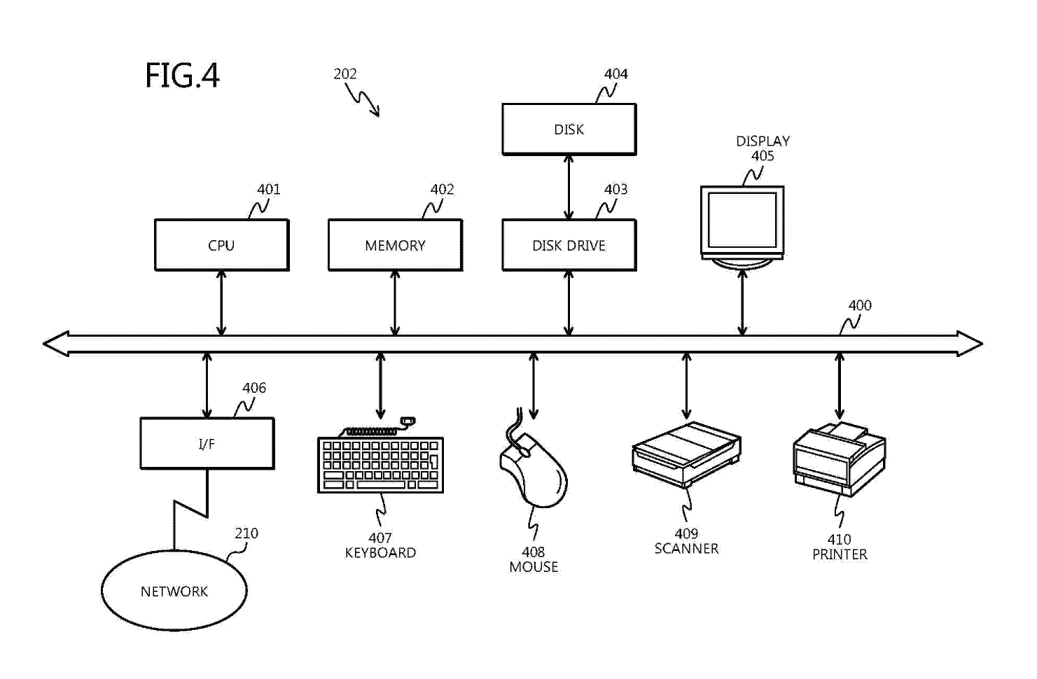

FIG. 4 is a block diagram of an example of hardware configuration of the client apparatus 202. In FIG. 4, the client apparatus 202 includes a CPU 401, memory 402, a disk drive 403, a disk 404, a display 405, an I/F 406, a keyboard 407, a mouse 408, a scanner 409, and a printer 410. The respective components are connected by a bus 400.

Here, the CPU 401 governs overall control of the client apparatus 202. The memory 402, for example, includes ROM, RAM, and flash ROM. In particular, for example, the flash ROM and the ROM store various types of programs and the RAM is used as work area of the CPU 401. A program stored in the memory 402 is loaded onto the CPU 401 and an encoded process is executed by the CPU 401.

The disk drive 403, under the control of the CPU 401, controls the reading and writing of data with respect to the disk 404. The disk 404 stores data written thereto under the control of the disk drive 403. The disk 404, for example, may be a magnetic disk, an optical disk, or the like.

The display 405 displays data such as documents, images, and functional information in addition to a cursor, icons, and toolboxes. The display 405, for example, may be a CRT, a TFT liquid crystal display, a plasma display, or the like.

The I/F 406 is connected to the network 210 by a communications line and is connected to an external device (e.g., the server 201 depicted in FIG. 2) via the network 210. The I/F 406 administers an internal interface with the network 210 and controls the input and output of data from external devices. The I/F 406, for example, may be a modem, a LAN adapter, or the like.

The keyboard 407 has keys for inputting characters, numerals, various instructions, etc., and performs input of data. The keyboard 407 may be a touch panel input pad, a numeric pad, etc. The mouse 408 moves the cursor, selects a range, moves and changes the size of windows, etc.

The scanner 409 optically reads images and takes in image data into the client apparatus 202. The scanner 409 may have an optical character reader (OCR) function. The printer 410 prints image data, text data, etc. The printer 410, for example, may be a laser printer, an ink jet printer, or the like.

The client apparatus 202, for example, may be configured to omit the scanner 409 and the printer 410 in the configuration above.

The storage contents of the tables 230, 240 included in the client apparatus 202 will be described with reference to FIGS. 5 and 6. The tables 230, 240 are implemented by a storage device such as the memory 402 and the disk 404 depicted in FIG. 4, for example.

FIG. 5 is an explanatory diagram of an example of storage contents of the activation app table 230. In FIG. 5, the activation app table 230 has fields for keywords, app IDs, and application names and activation app information (e.g., activation app information 500-1 to 500-3) is stored as records by setting information into the fields.

The keywords are phrases or combinations of phrases. The phrases registered as the keywords include, for example, disease names, drug names (e.g., prescription drugs and injection drugs), and symptoms. The combinations of phrases registered as the keywords include, for example, a combination of multiple symptoms and a combination of a body part and a symptom.

The app IDs are identifiers each uniquely identifying an app. The application names are names of apps. For example, the activation app information 500-1 is information indicating correlation between a keyword “Tamixxflu” and a prescription order tool AP2 and indicates that the use of the prescription order tool AP2 is deduced when the keyword “Tamixxflu” is input.

The activation app information in the activation app table 230 is created based on past clinical records of patients, for example. In this embodiment, it is assumed that apps identified from the app IDs and the application names in the activation app table 230 are installed in the client apparatuses 202 in the medical support system 200.

FIG. 6 is an explanatory diagram of an example of storage contents of the input keyword table 240. In FIG. 6, the input keyword table 240 has fields of app IDs, application names, input items and input keywords, and input keyword information (e.g., input keyword information 600-1, 600-2) is stored as records by setting information in the fields.

The app IDs are identifiers each uniquely identifying an app. The application names are names of apps. The input items are items that are input in the apps. The input keywords are candidates of phrases input in the input items of the apps. The phrases registered as the input keywords include disease names and drug names (e.g., including prescription and injection drugs), for example.

For example, the input keyword information 600-1 indicates an input keyword “Tamixxflu” input in an input item “drug name” of the prescription order tool AP2. The input keyword information with a “drug name” set in the input keyword field may be correlated with information indicating typical dosage and usage of the drug. For example, the input keyword information 600-1 is stored in correlation with the typical dosage “2 tablets” and usage “twice a day after breakfast and dinner for 5 days” of the drug name “Tamixxflu.”

The input keyword information in the input keyword table 240 is created based on past clinical records of patients, for example.

A screen example of a medical chart input screen 700 displayed on the display 405 of the client apparatus 202 will be described. The medical chart input screen 700 is an operation screen displayed when the medical chart input tool is activated in the client apparatus 202.

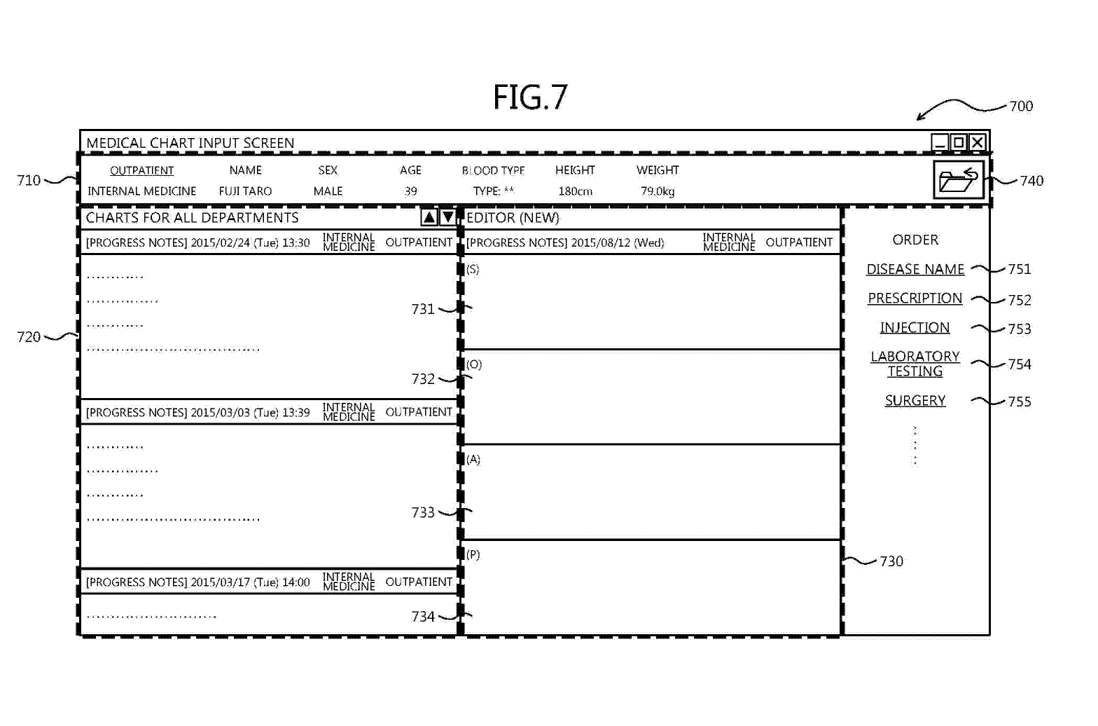

FIG. 7 is an explanatory view of an example of the medical chart input screen 700. In FIG. 7, the medical chart input screen 700 is an operation screen for inputting a patient's clinical chart and includes a patient information region 710, a past clinical chart region 720, and a new clinical chart region 730.

In the patient information region 710, for example, the screen displays a patient type (such as outpatient, inpatient, and home care), a clinical department, patient's name, sex, age, blood type, height, weight, etc. In the past clinical chart region 720, the screen displays patient's past clinical charts. The patient information and past clinical charts may be identified from patient's clinical information acquired from the server 201, for example.

In the new clinical chart region 730, the screen displays input fields 731 to 734 so that a patient's clinical chart may be input. For example, a patient's chief complaint is input in the input field 731. For example, objective information such as a result of laboratory testing is input in the input field 732. For example, observation, evaluation, determination, etc. by a physician are input in the input field 733. A future medical plan, medical scheme, etc. are input in the input field 734.

A button 740 on the medical chart input screen 700 may be clicked by user operational input using the keyboard 407 and the mouse 408 depicted in FIG. 4, for example, so as to terminate the input of the patient's clinical chart. Various types of information input into the input fields 731 to 734 are reflected on the patient's clinical information in the patient DB 220 depicted in FIG. 2, for example.

Order buttons (e.g., order buttons 751 to 755) displayed on the right side of the medical chart input screen 700 may be clicked to activate the order tools. For example, the order button 751 may be clicked to activate a disease name order tool AP1. The order button 752 may be clicked to activate the prescription order tool AP2.

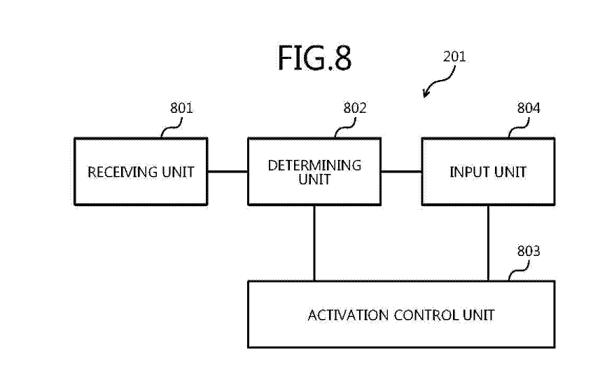

FIG. 8 is a block diagram of a functional configuration example of the client apparatus 202. In FIG. 8, the client apparatus 202 is configured to include an receiving unit 801, a determining unit 802, an activation control unit 803, and an input unit 804. The receiving unit 801 to the input unit 804 are functions acting as a control unit and, for example, the functions thereof are implemented by causing the CPU 401 to execute a program stored in a storage device such as the memory 402 and the disk 404 depicted in FIG. 4, for example, or by the I/F 406. Process results of the functional units are stored in a storage device such as the memory 402 and the disk 404, for example.

The receiving unit 801 receives input of a text document to the input fields. For example, the receiving unit 801 receives a text document including characters or character strings input to the input fields 731 to 734 of the medical chart input screen 700. The text document received as input may be text data converted from data including attributes such as a font and a line space like word-processor data, for example.

When detecting the completion of input of the text document to an input field, the determining unit 802 refers to the activation app table 230 (see, e.g., FIG. 5) to determine whether a keyword is included in the received text document. For example, the completion of input of the text document to an input field may be detected according to execution of an operation of confirming input characters or character strings (e.g., pressing of an Enter key) or may be detected according an operational input performed to switch the input field for input.

For example, first, the determining unit 802 executes natural language processing such as morphological analysis, syntax analysis, and semantic analysis for the received text document. As a result, the text document may be divided by delimiting each word or a relation between words may be identified.

The determining unit 802 then compares a divided word with the keywords in the activation app table 230 to search for a keyword matching the word. In this case, for example, the determining unit 802 may search for only the keyword perfectly matching the word or may also search for a keyword partially matching (e.g., forward matching or backward matching) the word.

If a keyword is retrieved, the determining unit 802 determines that the keyword is included in the received text document. On the other hand, if no keyword in the activation app table 230 is retrieved, the determining unit 802 determines that no keyword is included in the received text document.

The determining unit 802 may compare a combination of divided words with the keywords in the activation app table 230 to search for a keyword matching the combination of the words. The combination of words is identified from the meanings of words and the modification relations among words. The combination of words may be a combination of multiple symptoms or a combination of a body part and a symptom, for example.

If it is determined that a keyword is included in the text document, the activation control unit 803 carries out control of activating an app corresponding to the keyword. For example, the activation control unit 803 refers to the activation app table 230 to identify an app corresponding to the keyword included in the text document and activates the identified app. It is noted that an already activated app is excluded from being subject to activation.

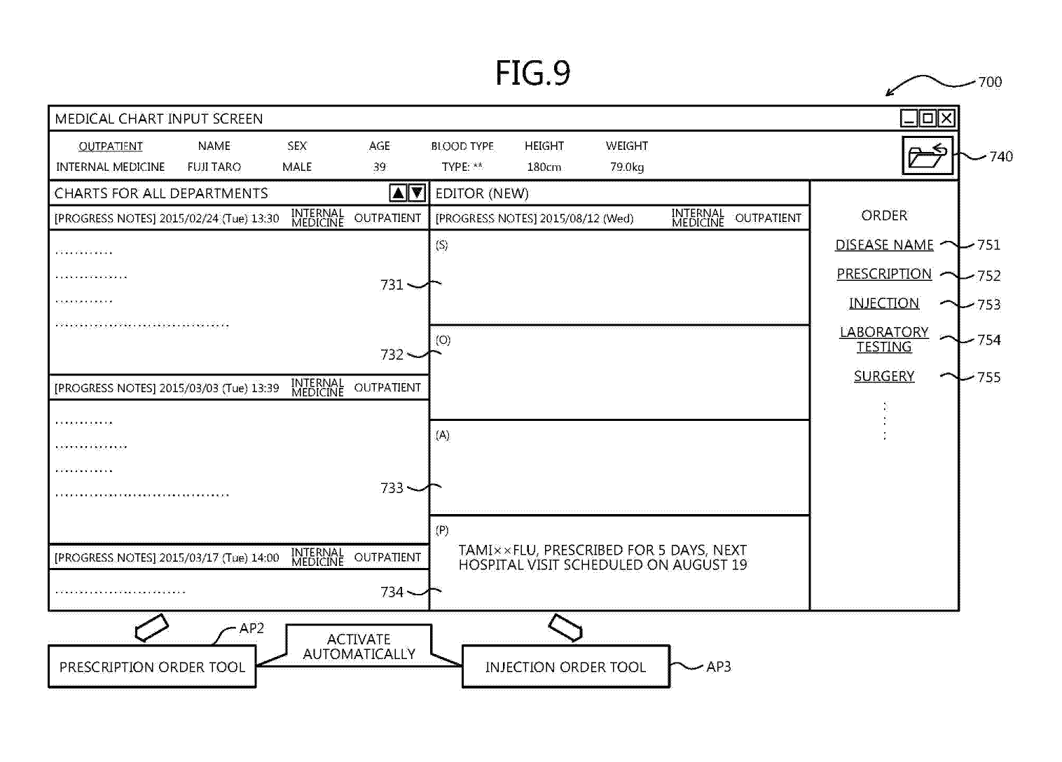

As a result, the app corresponding to the keyword included in the text document may be activated automatically. An example of activation of the app corresponding to the keyword included in the text document will be described later with reference to FIG. 9.

If a keyword is included in the text document, the determining unit 802 may extract from the text document a phrase corresponding to an input keyword to be input into an input item of the app corresponding to the keyword. The input item of the app is an item input into the app.

For example, in the case of the disease name order tool AP1, the input item is a “disease name” of a patient. In the case of the prescription order tool AP2, the input item is a prescribed “drug name,” a “dosage,” or a “usage”, for example. In the case of an injection order tool AP3, the input item is an injected “drug name” or a “dosage”, for example.

For example, first, the determining unit 802 refers to the input keyword table 240 (see, e.g., FIG. 6) to identify an input keyword to be input into the input item of the app corresponding to the keyword included in the text document. The determining unit 802 compares words divided from the text document with the identified input keyword to extract a phrase corresponding to the input keyword. In this case, the determining unit 802 may extract a phrase (word) perfectly matching the input keyword or may extract a phrase partially matching (e.g., forward matching or backward matching) the input keyword.

The input unit 804 inputs the extracted phrase into the input item of the activated app. For example, the input unit 804 identifies the input item corresponding to the extracted phrase from a screen displayed with the activation of the app. The input unit 804 inputs the extracted phrase into (the input box) of the identified input item.

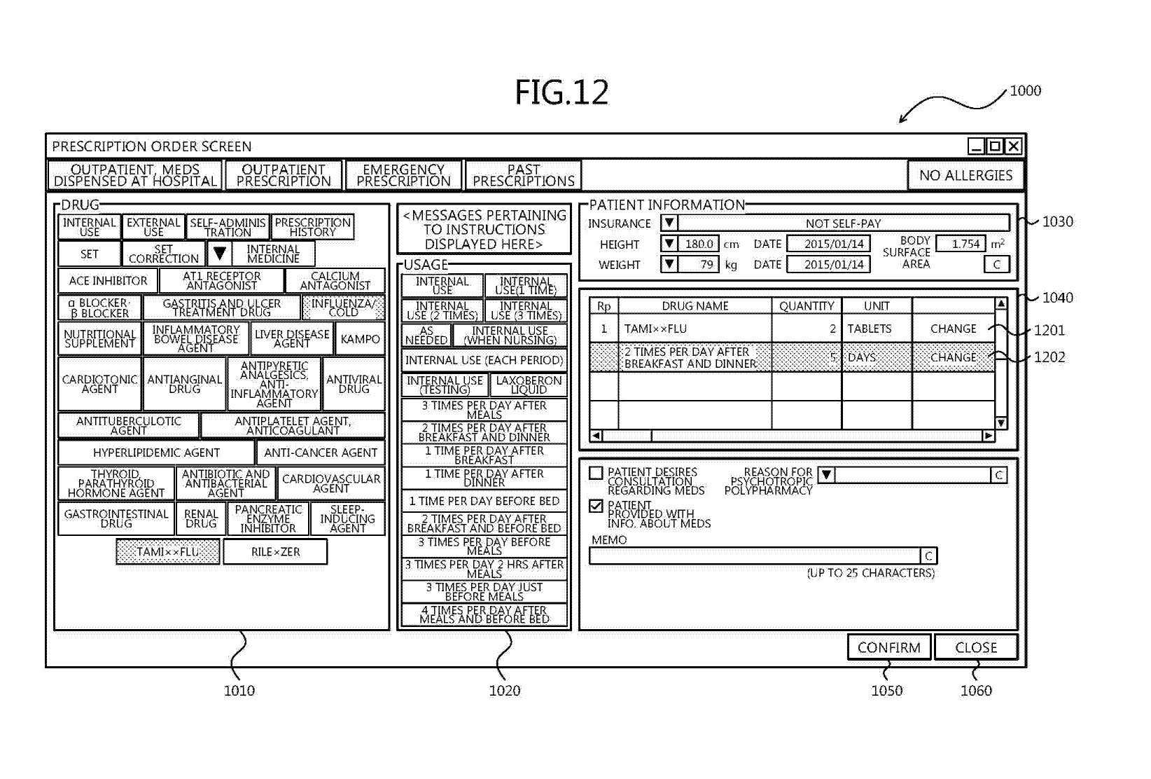

As a result, the phrase corresponding to the input item of the app may be extracted from the text document and automatically input as a default value into the input item of the activated app. An example of automatic input into the input item of the app will be described later with reference to FIG. 12.

For example, the determining unit 802 may refer to information indicating correlation between symptoms and disease names to extract a phrase representative of any of the symptoms from the text document and identify a disease name corresponding to the extracted phrase. In this case, the input unit 804 may input the identified disease name into the input item “disease name” of the disease name order tool AP1 when the disease name order tool AP1 is activated.

As a result, even if a disease name is not input, the name of a patient's disease may be predicted from the input symptom of the patient and may be input automatically into the input item “disease name” of the disease name order tool AP1.

For example, the determining unit 802 may refer to information indicating correlation between disease names and names of drugs to be prescribed (prescription drug names) to extract a phrase representative of a disease name from the text document and identify a drug name corresponding to the extracted phrase. In this case, the input unit 804 may input the identified drug name into the input item “drug name” of the prescription order tool AP2 when the prescription order tool AP2 is activated.

As a result, even if a drug name is not input, a drug name may be predicted from the input name of the patient's disease and may be input automatically into the input item “drug name” of the prescription order tool AP2.

Additionally, for example, the determining unit 802 may refer to the information indicating correlation between disease names and names of drugs to be prescribed to identify a drug name corresponding to a disease name predicted form a symptom. As a result, even if no disease name or drug name are input, the name of a patient's disease may be predicted from the input symptom of the patient and a name of a drug to be prescribed to the patient can further be predicted and may be input automatically into the input item “drug name” of the prescription order tool AP2.

A disease name determined from a patient's symptom may be different according to a clinical department. Therefore, the information indicating correlation between symptoms and disease names may be created for each clinical department. In this case, the determining unit 802 may refer to information indicating correlation between symptoms and disease names corresponding to the clinical department of a patient to identify the name of a patient's disease. As a result, prediction accuracy may be improved when a disease name is predicted from a patient's symptom.

The functions of the functional units described above (e.g., the receiving unit 801 to the input unit 804) may be implemented by the server 201, for example. In this case, for example, the server 201 receives input of a text document from the client apparatus 202 and instructs the client apparatus 202 to activate the app corresponding to a keyword included in the text document. For example, the server 201 extracts from the text document, a phrase corresponding the input item of the app to be activated and instructs the client apparatuses 202 to input the extracted phrase into the input item of the app.

An example of activation of an app corresponding to a keyword included in a text document will be described with reference to FIG. 9.

FIG. 9 is an explanatory view of an example of activation of an app corresponding to a keyword. In FIG. 9, a name of a drug to be prescribed to a patient, usage (the number of days), and a next scheduled hospital visit are input in the input field 734 of the medical chart input screen 700 by operational input by a user (e.g., a physician).

In this case, for example, the receiving unit 801 receives a text document “Tamixxflu, prescribed for 5 days, next hospital visit scheduled on August 19” input into the input field 734. The determining unit 802 refers to the activation app table 230 to determine whether a keyword is included in the received text document “Tamixxflu, prescribed for 5 days, next hospital visit scheduled on August 19.”

In this example, it is determined that the keyword “Tamixxflu” is included in the text document. In this case, for example, the activation control unit 803 refers to the activation app information 500-1, 500-2 in the activation app table 230 to activate the prescription order tool AP2 and the injection order tool AP3 corresponding to the keyword “Tamixxflu.”

As a result, the prescription order tool AP2 and the injection order tool AP3 corresponding to the keyword “Tamixxflu” input into the input field 734 may be activated automatically. Therefore, the user can activate the order tools AP2, AP3 without clicking the order buttons 752, 753 and can give instructions for details of prescription and injection.

A screen example of a prescription order screen 1000 displayed on the display 405 of the client apparatus 202 will be described. The prescription order screen 1000 is an operation screen displayed when the prescription order tool AP2 is activated in the client apparatus 202.

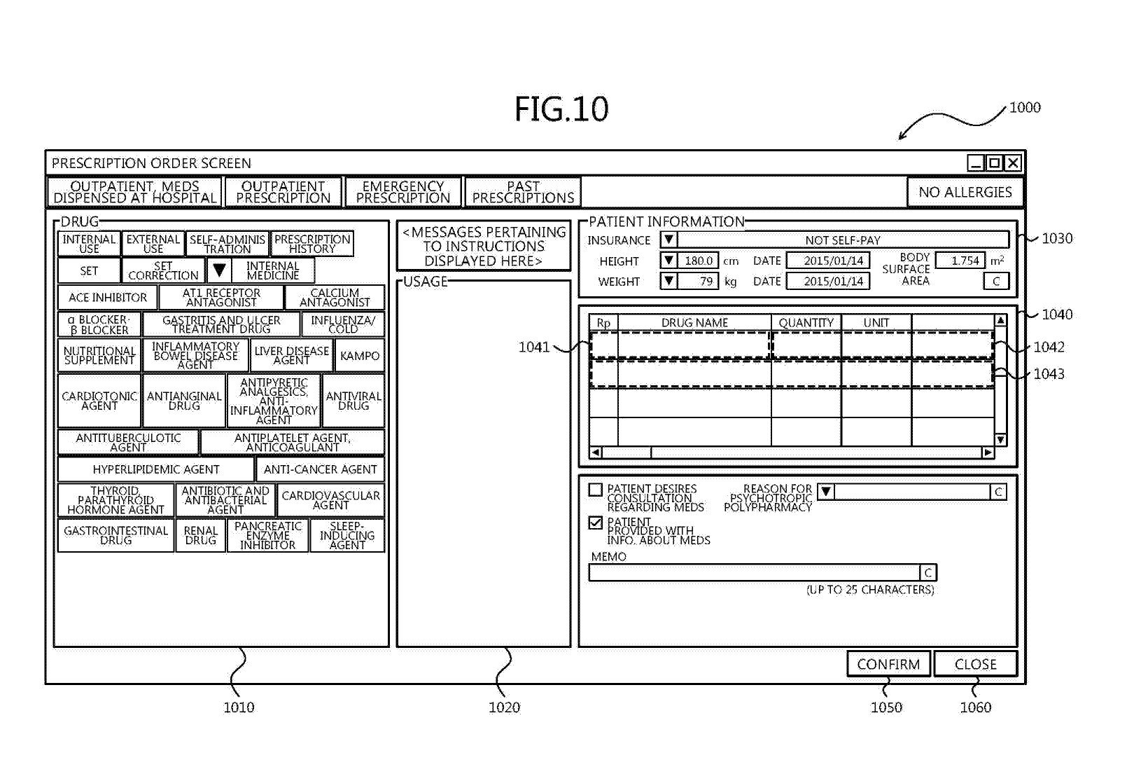

FIG. 10 is an explanatory view of an example of the prescription order screen 1000. In FIG. 10, the prescription order screen 1000 is an operation screen for inputting details of a prescription and includes a drug region 1010, a usage region 1020, a patient information region 1030, and a prescription order region 1040.

In the drug region 1010, the screen displays multiple drug types and displays drug names corresponding to a drug type selected out of the multiple drug types. In the example of FIG. 10, no drug type is selected out of the multiple drug types and, therefore, no drug name is displayed. For example, if the drug type “ACE inhibitor” is selected by user operational input, drug names corresponding to the drug type “ACE inhibitor” are displayed.

In the usage region 1020, the screen displays candidates for usage corresponding to the drug type selected out of the multiple drug types in the drug region 1010. In the example of FIG. 10, no drug type is selected out of the multiple drug types and, therefore, no candidate for usage is displayed. For example, if the drug type “ACE inhibitor” is selected by user operational input, candidates for usage corresponding to the drug type “ACE inhibitor” are displayed.

In the patient information region 1030, for example, the screen displays information such as the patient's height, weight, etc. referred to by a physician when determining a drug name, dosage/usage, etc.

In the prescription order region 1040, details of a prescription may be input. For example, when an input box 1041 is selected by user operational input, a drug name may be input. When an input box 1042 is selected, a dosage (quantity, unit) of a drug may be input. When an input box 1043 is selected, a usage (administration timing, the number of days of administration) of a drug may be input.

A confirm button 1050 on the prescription order screen 1000 may be clicked by user operational input so as to decide the prescription details and close the prescription order screen 1000. As a result, for example, the prescription details input in the prescription order screen 1000 (e.g., information input in the prescription order region 1040) are reflected on the patient's clinical information in the patient DB 220 (see FIG. 2) and a prescription order is achieved.

The registration of the decided prescription details to the patient DB 220 may be performed in response to termination of input of a clinical chart on the medical chart input screen 700. When a close button 1060 is clicked on the prescription order screen 1000 by user operational input, the prescription order screen 1000 may be closed without deciding the prescription details.

A screen example of an injection order screen 1100 displayed on the display 405 of the client apparatus 202 will be described. The injection order screen 1100 is an operation screen displayed when the injection order tool AP3 is activated in the client apparatus 202.

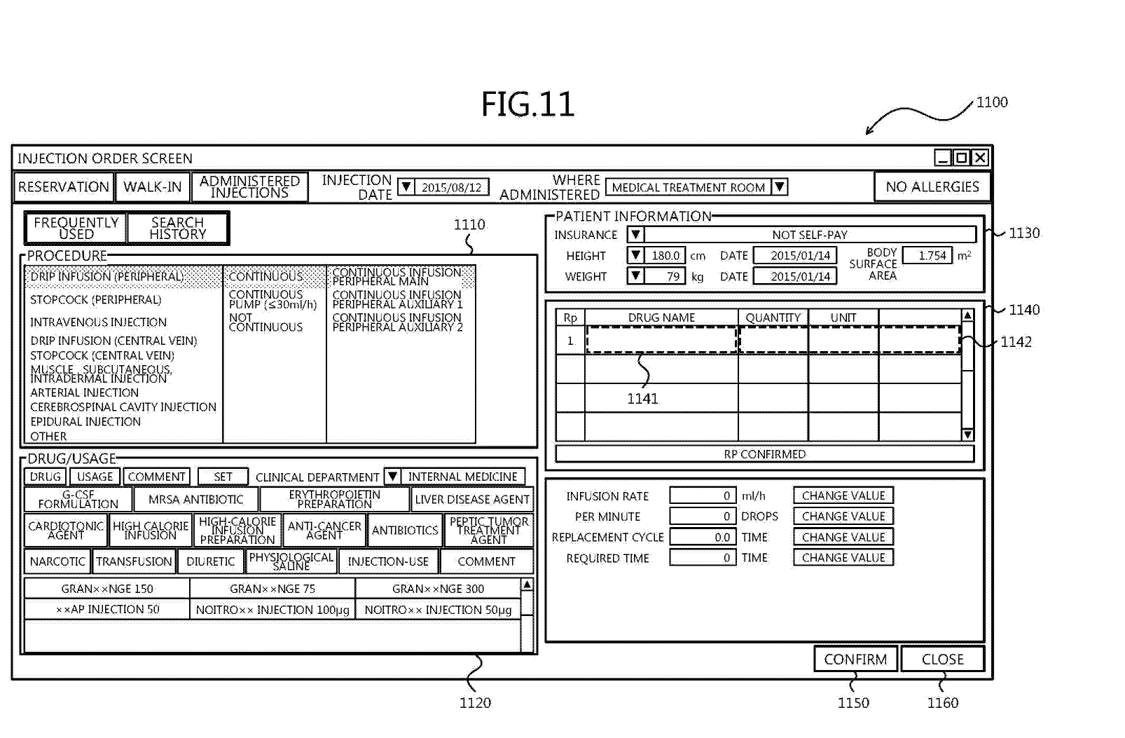

FIG. 11 is an explanatory view of an example of the injection order screen 1100. In FIG. 11, the injection order screen 1100 is an operation screen for inputting details of an injection and includes a procedure region 1110, a drug/usage region 1120, a patient information region 1130, and an injection order region 1140.

In the procedure region 1110, the screen displays multiple procedures so that a procedure of injection may be selected by user operational input.

In the drug/usage region 1120, the screen displays multiple drug types and displays drug names corresponding to a drug type selected out of the multiple drug types. In the example of FIG. 11, the drug type “G-CSF formulation” is selected and drug names corresponding to the drug type “G-CSF formulation” are displayed.

In the patient information region 1130, the screen displays information such as patient's height, weight, etc. referred to by a physician when determining a drug name, usage, etc.

In the injection order region 1140, details of injection may be input. For example, when an input box 1141 is selected by user operational input, a drug name may be input. When an input box 1142 is selected, a dosage (quantity, unit) of a drug may be input.

A confirm button 1150 on the injection order screen 1100 may be clicked by user operational input so as to decide the injection details and close the injection order screen 1100. As a result, for example, the injection details input in the injection order screen 1100 (e.g., information input in the injection order region 1140) are reflected on the patient's clinical information in the patient DB 220 (see FIG. 2) and an injection is ordered.

The registration of the decided injection details to the patient DB 220 may be performed in response to termination of input of a clinical chart on the medical chart input screen 700. When a close button 1160 is clicked on the injection order screen 1100 by user operational input, the injection order screen 1100 may be closed without deciding the injection details.

An example of automatic input into an input item of an app will be described.

FIG. 12 is an explanatory view of an example of automatic input into an input item of an app. An example of automatic input into an input item in the prescription order screen 1000 will be described by taking, as an example, a case where the prescription order tool AP2 is automatically activated as a result of input of a text document “Tamixxflu . . . (omitted) . . . hospital visit scheduled . . . ” in the input field 734 of the medical chart input screen 700 as depicted in FIG. 9.

First, when the prescription order tool AP2 is activated, the determining unit 802 refers to the input keyword table 240 to identify an input keyword to be input into the input item of the prescription order tool AP2. In this example, it is assumed that the input keywords “Tamixxflu” and “Loxxxnin” are identified from the input keyword information 600-1, 600-2 in the input keyword table 240.

The determining unit 802 compares words divided from the text document “Tamixxflu . . . (omitted) . . . hospital visit scheduled . . . ” with the identified input keywords to extract a phrase corresponding to the input keywords. In this example, the phrase “Tamixxflu” corresponding to the input keyword “Tamixxflu” is extracted. In this case, the input unit 804 inputs the extracted phrase “Tamixxflu” into the input box 1041 corresponding to the input item (drug name) in the prescription order screen 1000.

As a result, the phrase corresponding to the input item (drug name) in the prescription order screen 1000 may be extracted from the text document and may be input automatically as a default value into the input box 1041 corresponding to the input item (drug name) in the prescription order screen 1000.

As depicted in FIG. 6, the input keyword information 600-1 has the typical dosage “2 tablets” and usage “twice a day after breakfast and dinner for 5 days” of the drug name “Tamixxflu” stored in a correlated manner.

In this case, the input unit 804 inputs the dosage “2 tablets” identified from the input keyword information 600-1 into the input box 1042 corresponding to the input item (dosage) in the prescription order screen 1000. As a result, the preregistered typical dosage “2 tablets” of the drug name “Tamixxflu” may be input automatically as a default value into the input box 1042 corresponding to the input item (dosage) in the prescription order screen 1000.

The input unit 804 also inputs the usage “twice a day after breakfast and dinner for 5 days” identified from the input keyword information 600-1 into the input box 1043 corresponding to the input item (usage) in the prescription order screen 1000. As a result, the preregistered typical usage “twice a day after breakfast and dinner for 5 days” of the drug name “Tamixxflu” may be input automatically as a default value into the input box 1043 corresponding to the input item (usage) in the prescription order screen 1000.

As described above, the client apparatus 202 may input automatically the drug name, the dosage, and the usage into the respective input boxes 1041 to 1043 and can reduce the effort and time required when a physician inputs details of a prescription (the drug name, the dosage, and the usage), thereby improving work efficiency.

A change button 1201 on the prescription order screen 1000 may be clicked by user operational input so as to change the drug name and the dosage automatically input in the respective input boxes 1041, 1042. A change button 1202 may be clicked so as to change the usage input in the input box 1043.

Although the typical dosage and usage of the drug name “Tamixxflu” stored in a correlated manner in the input keyword information 600-1 are automatically input in the above description, this is not a limitation. For example, the client apparatus 202 may access the server 201 and refer to the prescription history of the patient (the patient of the medical chart being input) in the patient DB 220 to determine whether the drug name “Tamixxflu” has been prescribed for the patient. If the drug name “Tamixxflu” has been prescribed, the input unit 804 may input the dosage/usage of the drug name “Tamixxflu” for a previous prescription (e.g., the last prescription) into the respective input boxes 1042, 1043. As a result, the dosage/usage appropriate for patient's characteristics (e.g., sex, age, body type) may be input automatically.

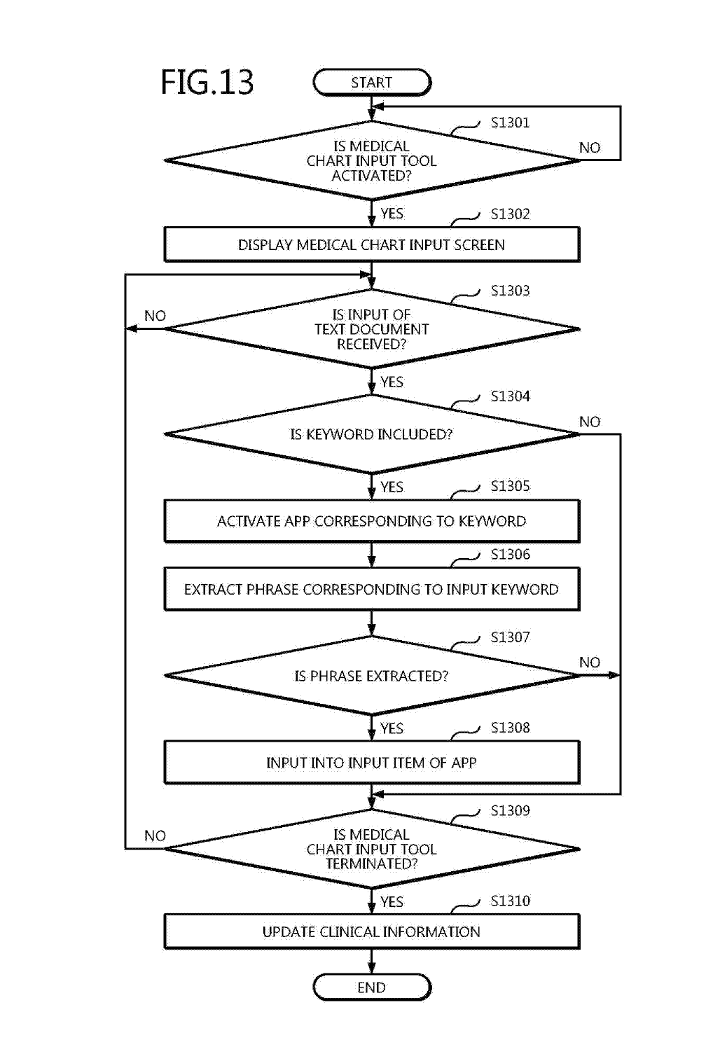

An application activation control process procedure of the client apparatus 202 will be described with reference to FIG. 13.

FIG. 13 is a flowchart of an example of the application activation control process procedure of the client apparatus 202. In the flowchart of FIG. 13, the client apparatus 202 determines whether the medical chart input tool for inputting a clinical chart of a patient is activated (step S1301).

The client apparatus 202 waits for activation of the medical chart input tool (step S1301: NO). If the medical chart input tool is activated (step S1301: YES), the client apparatus 202 displays the medical chart input screen 700 (step S1302).

The client apparatus 202 determines whether an input of a text document is received to the input fields 731 to 734 of the medical chart input screen 700 (step S1303). The client apparatus 202 waits for input of a text document (step S1303: NO).

If an input of a text document is received (step S1303: YES), the client apparatus 202 detects completion of the input of the text document into the input fields and then refers to the activation app table 230 to determine whether a keyword is included in the received text document (step S1304). If a keyword is not included (step S1304: NO), the client apparatus 202 goes to step S1309.

On the other hand, if a keyword is included (step S1304: YES), the client apparatus 202 refers to the activation app table 230 to activate an app corresponding to the keyword (step S1305). It is noted that an already activated app is excluded from being subject to activation.

The client apparatus 202 refers to the input keyword table 240 to extract from the received text document, a phrase corresponding to an input keyword to be input into an input item of the activated app (step S1306). The client apparatus 202 determines whether a phrase corresponding to an input keyword is extracted (step S1307).

If a phrase corresponding to the input keyword is not extracted (step S1307: NO), the client apparatus 202 goes to step S1309. On the other hand, if a phrase corresponding to the input keyword is extracted (step S1307: YES), the client apparatus 202 refers to the input keyword table 240 to input the extracted phrase into the corresponding input item of the activated app (step S1308).

The client apparatus 202 determines whether the medical chart input tool is terminated (step S1309). If the medical chart input tool is not terminated (step S1309: NO), the client apparatus 202 returns to step S1303. On the other hand, if the medical chart input tool is terminated (step S1309: YES), the client apparatus 202 updates patient's clinical information in the patient DB 220 (step S1310) to terminate a series of processes of this flowchart.

As a result, an app corresponding to a keyword included in the text document may be activated automatically. A phrase corresponding to an input item of the app may be extracted from the text document and may be input automatically as a default value into the input item of the activated app.

As described above, the client apparatus 202 according to the embodiment may refer to the activation app table 230 and, if a keyword is included in the received text document, my activate an app corresponding to the keyword.

As a result, the app corresponding to the keyword included in the text document may be activated automatically. For example, order tools may be activated automatically for registering a disease name and giving instructions for details of treatment such as prescription, injection, laboratory testing, and surgery.

If an app is activated, the client apparatus 202 may refer to the input keyword table 240 to extract a phrase corresponding to an input keyword of the app from a text document and may input the extracted phrase into an input item corresponding to the app.

As a result, the phrase corresponding to the input item of the app may be extracted from the text document and may be input automatically as an initial value into the input item of the activated app. For example, a phrase corresponding to the input item (drug name) of the prescription order screen 1000 may be extracted from the text document and may be input automatically as a default value in the input box 1041 corresponding to the input item (drug name) of the prescription order screen 1000.

If the input keyword is a drug name, the client apparatus 202 may refer to the input keyword table 240 and may also input information indicating dosage/usage corresponding to the drug name into the input item in which the dosage/usage is input in the activated app.

As a result, typical dosage/usage of a drug may be input automatically as a default value into the input item in which the dosage/usage is input in the activated app. For example, preregistered typical dosage/usage of a drug may be input automatically as a default value into the input boxes 1042, 1043 in the prescription order screen 1000.

Thus, the medical support system 200 may reduce operations to be performed by a physician during input of a medical chart etc. to improve work efficiency and may prevent the physician's thought process from being disrupted by performance of an app activation operation, etc., thereby supporting clinical work.

The storage contents of the activation app table 230 and the input keyword table 240 may be updated periodically, for example, based on the storage contents of the patient DB 220. For example, the server 201 refers to the clinical charts of the past several years in the patient DB 220 to count for each phrase included in the clinical charts (phrase input to the medical chart input screen 700), the number of times that a disease name is registered by using the disease name order tool AP1 when the phrase is input. The server 201 may correlate and register to the activation app table 230, the top N phrases in descending order of the counted number of times with the identification information (the app ID, the application name) of the disease name order tool AP1. This enables accurate retrieval of a keyword from which use of an app is deduced when the keyword is input to the medical chart input screen 700.

Although the application activation control method described in the embodiment is applied to a system supporting medical care in medical facilities in the example of the above description, this is not a limitation. For example, this application activation control method is generally applicable to systems activating and making another app related to an input keyword available during data input using a certain app.

The application activation control method described in the present embodiment may be implemented by executing a prepared program on a computer such as a personal computer and a workstation. The application activation control program is stored on a non-transitory, computer-readable recording medium such as a hard disk, a flexible disk, a CD-ROM, an MO, and a DVD, read out from the computer-readable medium, and executed by the computer. The application activation control program may be distributed through a network such as the Internet.

In conventional techniques, when another application is activated and used during use of a certain application, an operation of activating the other application must manually be performed, resulting in an increase in the number of user's operations.

One aspect of the present invention achieves an effect in that an application may be activated automatically.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory, computer-readable recording medium storing therein, an application activation control program causing a computer to execute a process comprising:
receiving an input of a text document into an input field; and
detecting completion of the input of the text document into the input field and referring to a storage device configured to store therein keywords and identification information of applications in a correlated manner, the computer further activating an application corresponding to the keyword, when a keyword is included in the received text document.

2. The recording medium according to claim 1, wherein
the storage device further stores input keywords to be input into input items of the application, and
the process further comprises:
extracting from the text document, a phrase corresponding to an input keyword to be input into an input item of the application, when the application is activated; and
inputting the extracted phrase into the input item of the activated application.

3. The recording medium according to claim 2, wherein
the text document includes a character or a character string input in an input field of a clinical chart, and
the keyword is a phrase representative of at least one of a disease name, a drug name, and a symptom.

4. The recording medium according to claim 3, wherein
the application is an application for registering a disease name or giving instructions for details of treatment.

5. The recording medium according to claim 3, wherein
the input keyword is a phrase representative of a name of a drug to be prescribed or injected, when the application is an order tool for giving instructions for details of a prescription or injection, and
the input item is an input item in which a name of a drug to be prescribed or injected is input.

6. The recording medium according to claim 5, wherein
the storage device further stores information indicating dosage/usage corresponding to the drug name, when the input keyword is a drug name, and
the inputting includes
inputting the extracted phrase into the input item and inputting the information indicating the dosage/usage into an input item in which dosage/usage is input in the application.

7. The recording medium according to claim 3, wherein
the input keyword is a phrase representative of a disease name, when the application is an order tool for registering the disease name of a patient, and
the input item is an input item in which the disease name of the patient is input.

8. An application activation control method comprising:
receiving, by a computer, an input of a text document into an input field; and
detecting, by the computer, completion of the input of the text document into the input field and referring to a storage device configured to store therein keywords and identification information of applications in a correlated manner, the computer further activating an application corresponding to the keyword, when a keyword is included in the received text document.

9. An information processing apparatus comprising:
a control circuit configured to:
receive an input of a text document into an input field; and
detect completion of the input of the text document into the input field, refer to a storage device configured to store therein keywords and identification information of applications in a correlated manner, and activate an application corresponding to the keyword, when a keyword is included in the received text document.
